(19) United States
(12) Patent Application Publication
(10) Pub. No.: US 2024/0369752 A1
(43) Pub. Date: Nov. 7, 2024

(54) SYSTEMS AND METHODS FOR ENGRAVING OF NANO VOID-DASH METASURFACE INTO SUBSTRATE TO GENERATE BIREFRINGENCE IN THE SURFACE LAYER

(71) Applicant: Lawrence Livermore National Security, LLC, Livermore, CA (US)

(72) Inventors: Eyal FEIGENBAUM, Livermore, CA (US); Nathan James RAY, Tracy, CA (US)

(21) Appl. No.: 18/309,925

(22) Filed: May 1, 2023

(51) Int. Cl. G02B 5/30

(52) U.S. Cl. CPC G02B 5/3083

(57) ABSTRACT

The present disclosure relates to a method for forming a component having a birefringent characteristic. The method may involve forming a first mask using nanoparticles of metallic material on a surface of a substrate of the component, and then performing a first etching operation at a first angle relative to the surface of the substrate using the nanoparticle mask to remove material from the surface to create surface features projecting from the upper surface in accordance with the nanoparticle mask. A second mask may be formed on the upper surface of the substrate by depositing an additional quantity of metallic material at a second angle, different from the first angle, to create a plurality of regions adjacent each one of the rods where the quantity of metallic material is absent. A second etching operation is then performed at a third angle using the second mask to create a plurality of voids at each of the regions. The voids help to form a metasurface which imparts the birefringence characteristic to the component.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to the manufacture of metasurfaces, and more particularly to systems and methods for forming voids in a substrate of a component or structure to create a metasurface which generates a birefringence characteristic for the component or structure.

### BACKGROUND

The statements in this section merely provide background information related to the present disclosure and may not constitute prior art.

Laser systems often rely on waveplates to control the polarization state of the light. One common utilization is to use a waveplate placed between two linear polarizers to control the transmission without introducing absorbing elements. This approach is of special importance to higher laser power and intensity applications.

Another approach is to propagate the light emitted from a laser in linear polarization at a first section of the system, and then convert closer to the output to circular polarization for light-matter interaction advantages.

Relying on the birefringence native to certain materials to form a waveplate has some shortcomings. For one, specialized materials often have a lower laser damage threshold than the other optical materials used in the laser system. Another shortcoming is that for some wavelengths of operation, such specialized materials are less abundant than ones used for optics, more expensive, and more difficult to obtain.

Alternative approaches to using materials with native birefringence have involved structuring the surface layer of a component such that it breaks the symmetry between the two principal linear polarization components. This approach thus produces a difference in retardation, and as a result a birefringence at the surface layer of the component.

One specific prior art technique for addressing the above challenge is using Glancing Angle Deposition (GLAD) to form tilted rods. A downside of this technique, as well as others that are based on deposition, is that a deposited material, while having similar optical properties, typically has weaker optical and mechanical durability.

Another prior art technique is based on using lithographically to produce a mask forming a sub-wavelength grating. However, this approach is limited by the ability to write the mask over a large enough aperture at shorter wavelengths. For example, for longer operation optical wavelengths, shorter wavelength laser interference can be used to pattern the grating on a large aperture. However, for short operation wavelength, such as the ultraviolet, that becomes very challenging, especially on larger optical apertures.

Still another prior art approach is to etch at an angle of the nano-particle mask, which addresses the durability and short-wavelength limitations mentioned above. However, the metasurface birefringence is linked to the depth of the metasurface, which is limited by the nano-particle height or thickness. This limitation could become a drawback for using this particular technique.

### SUMMARY

This section provides a general summary of the disclosure, and is not a comprehensive disclosure of its full scope or all of its features.

In one aspect the present disclosure relates to a method for forming a component having a birefringent characteristic. The method may comprise forming a first mask on a surface of a substrate of the component, the first mask being formed by a plurality of metallic nanoparticles. The method may further include performing a first etching operation, at a first angle, using the nanoparticle mask to remove material from the surface to create surface features projecting from the surface in accordance with the nanoparticle mask. The method may further include forming a second mask on the surface of the substrate by depositing an additional quantity of metallic material at a second angle relative to the surface, the second angle being different from the first angle. The surface features help to create a plurality of regions adjacent each one of the surface features where the additional quantity of metallic material is absent. The method may further include performing a second etching operation at a third angle relative to the surface of the substrate, using the second mask to remove additional substrate material from the substrate. This creates a plurality of voids in the surface of the substrate at each of the regions, with the voids helping to form a metasurface which imparts birefringence to the component.

In another aspect the present disclosure relates to a method for forming a component having a birefringent characteristic. The method may comprise forming a plurality of nanoparticles residing on the upper surface of a substrate, with the plurality of nanoparticles forming a first mask on the upper surface of the substrate. The method may further include performing a first reactive ion etching operation using the first mask, and at an angle normal to the upper surface of the substrate, to remove material from the upper surface of the substrate to create vertical rods projecting from the upper surface in accordance with the first mask. The vertical rods are arranged in accordance with the locations of the nanoparticles of the first mask. The method may further include forming a second mask on the upper surface of the substrate by depositing an additional quantity of metallic material on the upper surface at an angle non-normal to the upper surface. The second mask covers the upper surface except for a plurality of linear, dash-like regions adjacent each one of the rods where the additional quantity of metallic material is absent. The method may further include performing a second etching operation using the second mask to create a plurality of dash-like voids at each of the dash-like regions. The dash-like voids help to form a metasurface which imparts birefringence to the component.

In still another aspect the present disclosure relates to a waveplate. The waveplate may include a substrate and a plurality of elongated voids formed in a surface of the substrate. The voids have at least one of a desired pattern or desired periodicity on the surface of the substrate, and also have a depth less than a thickness of the substrate, which provides a birefringent characteristic to the waveplate.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level side cross-sectional view of a substrate after having a mask formed by nanoparticles deposited thereon, as a first operation in forming a metasurface in accordance with the present disclosure;

FIG. 2 is a plan view looking down on the substrate of FIG. 1;

FIG. 3 is a side cross-sectional view showing a mask formed by an etching operation on the substrate of FIG. 2, in which the nanoparticles are used as a mask, and the etching has transferred the mask pattern into the substrate to form a plurality of vertically oriented “rods” in accordance with the mask pattern;

FIG. 4 is a plan view looking straight down on the substrate of FIG. 3, illustrating the circular shape of each of the rods;

FIG. 5 is a high level cross-sectional side view of the substrate of FIG. 4 after an additional deposition operation to deposit an additional quantity of nanoparticles to modify the mask illustrated in FIGS. 3 and 4;

FIG. 6 is a plan view looking straight down on the substrate of FIG. 5 better illustrating the resulting plurality of linear “dashes” produced by a combination of depositing the nanoparticles at an angle non-perpendicular to the surface of the substrate, and the action of the vertical rods obstructing the deposition of the nanoparticles within well defined, rectangular areas adjacent to each vertical rod;

FIG. 7 is a side cross-sectional view of the substrate after having performed a directional etching operation normal to the surface of the substrate to generate a plurality of voids in the surface each having a dash-like shape;

FIG. 8 is a top view of the substrate of FIG. 7 further illustrating the dash-like voids in the upper surface of the substrate;

FIG. 9 is a perspective view of a cross-section of the finished substrate in FIG. 8 further helping to illustrate the dash-like voids in the upper surface of the substrate, and with arrows illustrating the direction of incoming light and the two principal axes of polarization of the incoming light;

FIG. 10 shows a planar view of a portion of a component in accordance with another method of the present disclosure where the nanoparticles are formed as shown in FIGS. 1 and 2, and the deposition performed at an angle closer to normal to the upper surface of the substrate, to produce crescent-shaped voids adjacent each of the rods;

FIG. 11 is a high level block diagram of a system that may be used to deposit nanoparticles to form one or more mask layers described in connection with FIGS. 1, 2, 5 and 6;

FIG. 12 is a high level block diagram of one example of an etching system that may be used to perform the etching operations described in connection with FIGS. 3, 4, 7 and 8; and

FIG. 13 is a high level flowchart of one example of operations that may be performed carrying out a method in accordance with the present disclosure.

### DETAILED DESCRIPTION

Example embodiments will now be described more fully with reference to the accompanying drawings.

The present disclosure relates to systems and methods for the formation of air void dashes, which are engraved into a substrate, to generate a metasurface that has birefringence. This enables formation of a waveplate from commonly available and durable optical materials (e.g., fused silica glass) that naturally do not have optical birefringence. The systems and methods described herein are based on formation of an etching mask made of nano-particles having nanometric spacing, and enable waveplates to be constructed at even shorter wavelengths (e.g., ultraviolet) that what would ordinarily be possible with previous methods waveplate construction methods.

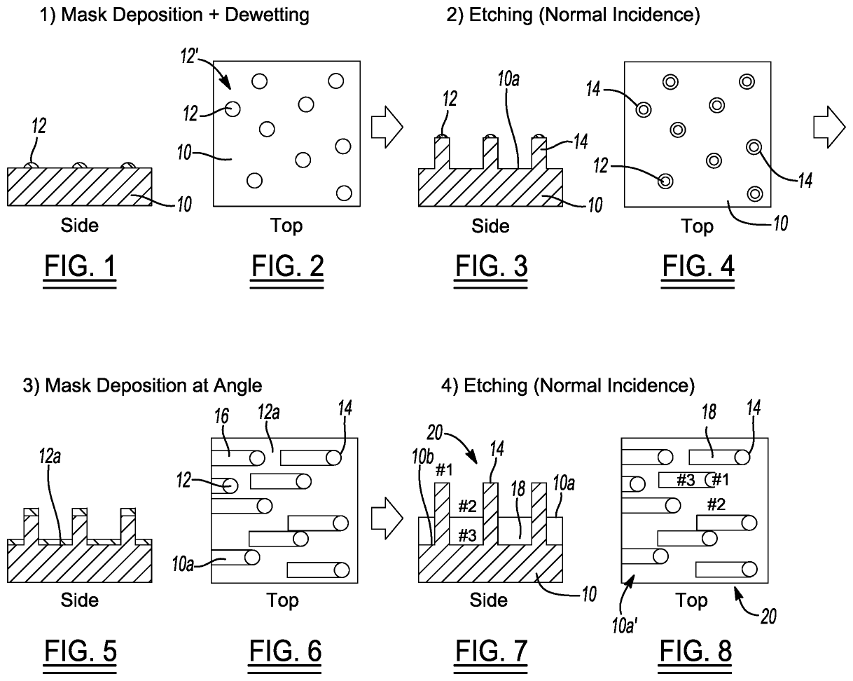

Referring to FIGS. 1 and 2, a substrate 10 is shown after forming of nanoparticles 12 thereon. The nanoparticles 12 may be formed in one process by performing a dewetting operation on a provided metal layer of material. In another process the nanoparticles 12 may be formed by a well-known spin coating operation. Both processes are contemplated by the present disclosure, and the present disclosure is not limited to any specific manner of creating the nanoparticles 12. However, simply for convenience, the following discussion will reference the nanoparticles being formed by a dewetting operation.

The substrate 10 in this example forms a planar, flat component. However, it will be appreciated that the teachings presented herein could be used to form non-planar and non-flat structures as well. The nanoparticles 12 in this example have a nanometric spacing, and form a first nanoparticle mask 12′. If a dewetting operation is used to form the first nanoparticle mask 12′, then the deposited mask material used may be, without limitation, a few nanometers of metal such as Au or PT or other suitable metallic mask material. The dewetting may be performed by applying heat, for example and without limitation, heat from a furnace or heat generated by laser irradiation. The formed nanoparticle periodicity, shape, and height are a function of a plurality of factors including, but not limited to, an initial layer thickness, the material system being used to perform the deposition and/or dewetting operations, an induced heating temperature during the dewetting operation, and/or other process parameters. The substrate 10 may be formed by any suitable material, for example and without limitation, fused silica.

Referring now to FIGS. 3 and 4, an etching operation, in one example a directional etching operation, for example and without limitation, a reactive ion beam etching (RIBE) or reactive ion etching (RIE) operation, may be performed on the mask 12′. In this operation a reactive ion etching beam is directed at a first angle relative to the upper surface 12a of the substrate 12, which is an angle normal to an upper surface 12a of the substrate 10, and used to transfer the nano-particle pattern of the mask 12′ into the substrate 10 material. This produces a plurality of surface features, which in one example form upstanding surface features. In one specific example these upstanding surface features form vertical rods 14. The vertical rods 14 are formed in a pattern which is in accordance with the pattern of the mask 12′, with the rods 14 in this example orientated generally normal to the upper surface 10′ of the substrate 10. In this example the rods 14 are cylindrical in cross-sectional shape, but they need not be cylindrical, and may be formed to have other cross-sectional shapes (e.g., square, rectangular, oval, oblong, triangular, etc.). The resulting rods 14 each have a predetermined length, and the lengths of all of the rods 14 are generally uniform and consistent. The length is a combination of a number of variables including, but not necessarily limited to, the etch time, the etching gas flow rate and composition, the chamber pressure, the applied bias power, and the etch ratio between the mask 12′ material and the substrate 10 material. At the end of this initial operation the mask 12′ material may or may not be fully removed from the substrate 10. FIGS. 3 and 4, however, show a small amount of mask material 12 still present on the top of each rod 14.

Referring now to FIGS. 5 and 6, a second deposition operation for depositing an additional quantity of mask material 12a will be described. The second deposition operation includes depositing an additional quantity of mask material 12a onto the substrate 10 at a second angle. However, the second angle is not an angle normal to the upper surface 10a of the substrate 10, but rather an angle non-perpendicular (i.e., acute) to the upper surface 10a. This deposition of the additional quantity of mask material 12a at an angle acute to the upper surface 10a results in a layer of the additional mask material 12a covering an additional portion of the upper surface 10a of the substrate 10, and forming what may be termed an additional or secondary mask 12a′ (FIG. 6). In this one example, the additional quantity of mask material 12a covers the entire upper surface 10a of the substrate 10 except for regions adjacent each rod 14. In this example the regions form elongated, linear dash-like regions 16 formed adjacent to, and co-linear with, associated ones of the rods 14. These linear dash-like regions 16 are the regions of the upper surface 10a that are shadowed by the rods 14, formed at the previous etching operation, and the original upper surface 10a of the substrate 10 is visible in each of these linear dash-like regions 16. The length of the shadowed dash-like regions 16 (i.e., left-to-right distance in FIG. 6) is controlled by geometrical considerations relating to each rod's 14 height and the precise deposition angle at which the additional quantity of mask material 12a is deposited at relative to the upper surface 10′ of the substrate. The width of each dash-like area 16 is controlled by the nominal diameter of its associated rod 14 and nanoparticle 12 (later to be transferred into the rod's 14) diameter. Therefore, the aspect ratio of the linear dash-like regions 16 is controlled by different processes and selected in an engineered manner to be different, and more specifically to result in a symmetry break and birefringence in the next manufacturing operation. The deposition of the additional quantity of mask material may be carried out by tilting a support table on which the substrate 10 is being supported at the desired angle, or possibly by even positioning the deposition component which is depositing the additional quantity of mask material 12a at a desired angle relative to the upper surface 10a of the substrate 10. Both arrangements are contemplated by the present disclosure.

The thickness of the layer formed by the additional quantity of mask material 12a deposited in FIGS. 5 and 6 could be much deeper (i.e., thicker) than the thickness of the dewetted first mask layer (i.e., the thickness or height of the nanoparticles 12), as dewetting is not performed on the layer formed by the additional quantity of mask material 12a. This means that a much deeper metasurface may be formed in the substrate 10 using etching, thus overcoming the limitations of existing angled etching techniques. The specific material used for the additional mask material 12a, as well as the thickness of the layer formed by the additional mask material, may could be the same or different than the material used to form the initial or first nanoparticle mask 12′, and its height or thickness. The result is a second mask 12a′ made up of the dash-like regions 16 and the rods 14.

Referring now to FIGS. 7 and 8, a second directional etching operation (e.g., but not limited to, RIE, RIBE) will be described. This second directional etching operation may be performed at a third angle, which is an angle normal (or substantially normal) to the upper surface 10a of the substrate 10. This second directional etching operation removes material from the substrate 10 to form a plurality of recesses or voids adjacent each of the rods 14. The recesses or voids have a desired pattern or desired periodicity, and in this example form elongated, linear dash-like regions or voids 18 (hereinafter simply “dash-like voids 18”) at the locations of the dash-like regions 16. The dash-like voids 18 in this example are identical, or substantially identical, in cross-sectional shape, to the dash-like regions 16, with a uniform depth within the dash-like regions 16. A bottom wall 10b of each dash-like void 18 is flat or planar in this example, but does not necessarily need to be flat or planar. The depth of the dash-like voids 18 may be controlled by a plurality of operational factors including, but not limited to, the length (i.e., time duration) of the second directional etching operation, the thickness of the additional mask material 12a forming the secondary mask 12a′, which was deposited in the previous deposition operation, the etch ratio between the additional mask material 12a and the substrate 10, and possibly other factors as well. The finished component 20 forms a component having a new birefringent metasurface 10a′. In one example the component 20 forms a waveplate.

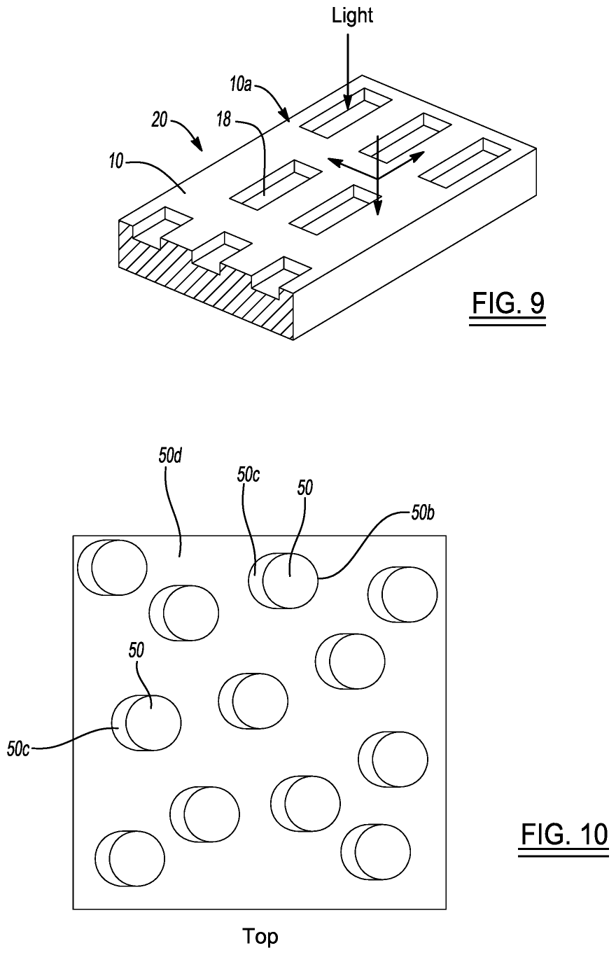

FIG. 9 shows a cross-sectional perspective view of a portion of the component 20 after the rods 14 have been removed, which is an optional operation. The rods 14 are parasitic features of the above-described process and are not needed to form the metasurface 10a′ of the component 20.

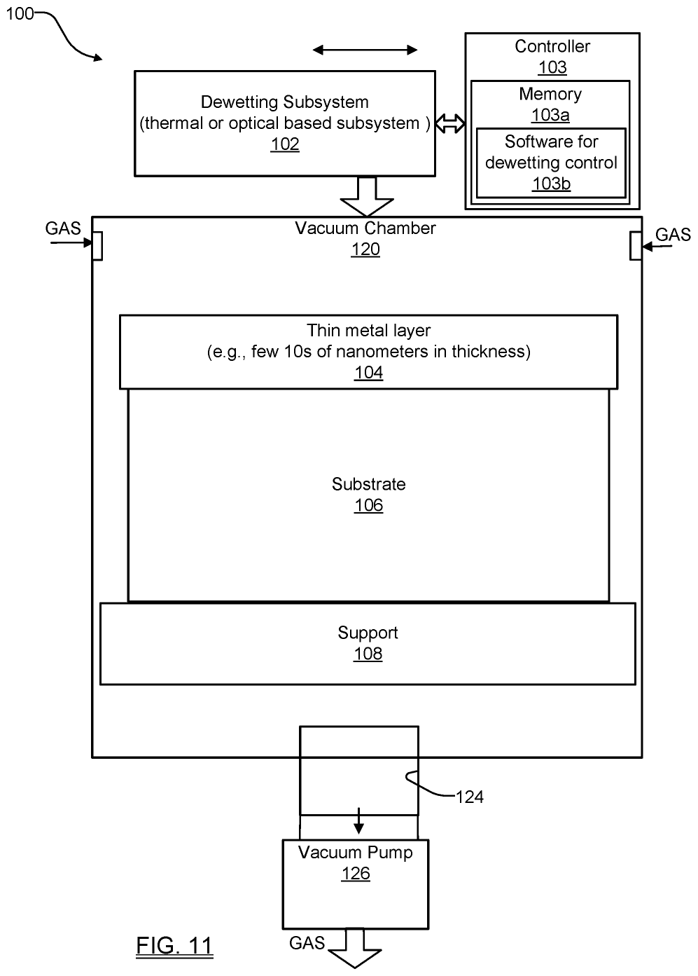

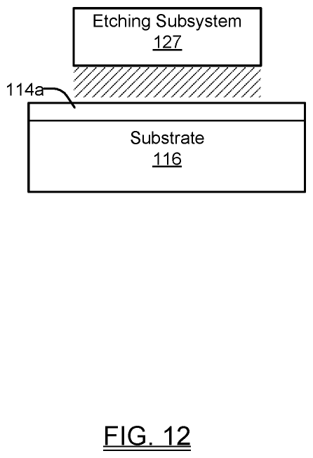

Referring to FIG. 10, in another implementation of the method described above, one can form mask nanoparticles 50 as described in connection with FIGS. 1 and 2 above, with a shorter etching time to get shorter rods. Still further, depositing the mask 12a′ at a shallower angle (i.e., closer to normal to the upper surface 10a), will create dash-like regions 50c in a metallic layer 50d having a crescent-shaped appearance, as shown in FIG. 10, where the upper surface 10a of the substrate 10 is exposed. The pseudo-circular shape of the rods 50b helps to produce the crescent-shaped regions 50c, which still provide an existing elongation and symmetry break.

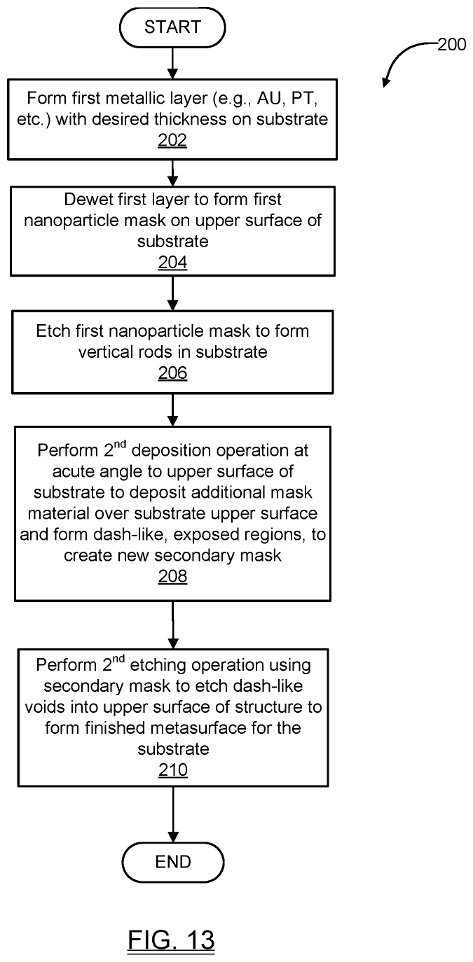

FIGS. 11 and 12 show high level diagrams of examples of systems that may be used to perform the methods described herein. The system 100 shown in FIG. 11 may be used to create the finished structure 20 in FIG. 8. The system 100 in this example may include a dewetting subsystem 102, which may be a thermally based subsystem or an optically based subsystem that serves to heat a thin metal material layer 104 present on a substrate 106. One suitable thermally based dewetting subsystem may be an Au, Pt, or other suitable thin metal layer mask over a substrate material, for example, fused silica. An example of an optically based dewetting subsystem may be an electromagnetic waveform generator that can be a raster scanned light beam or otherwise a light beam that is reshaped by passing it through an illumination mask before the beam irradiates the thin metal material layer 104. In another example the dewetting subsystem 102 may be a laser which provides a dynamically reshaped laser beam using spatial light modulators (e.g., digital micromirror device (DMD)). And as noted above, an spin coating process could instead be used to create the nanoparticles and the nanoparticle mask.

A controller 103 may be included for communicating with and controlling the dewetting subsystem 102. The controller 103 may include a non-volatile memory 13a (e.g., RAM, ROM, etc.) for storing a software module 103b which helps to control the dewetting subsystem 102 in repeatedly carrying multiple dewetting operations when increasing the thickness of the thin metal material layer 100a, as will be described in greater detail in the following paragraphs. An etching subsystem 127 is shown in FIG. 12 which may be an ion based etching subsystem (e.g., Reactive Ion Beam Etching (RIBE); Reactive Ion Etching (RIE)), for etching the substrate 10 using a mask layer 114a as described in the discussion of FIGS. 1-8.

Referring now to FIG. 13, a high level flowchart 200 is shown illustrating various operations that may be performed in creating the finished component 20 with the metasurface 10a′. This example assumes a dewetting operation is being used to create the nanoparticles, but as noted above spin coating could be used instead.

Initially at operation 202, when using a dewetting operation, a quantity of a metallic material (e.g., Au, Pt, etc.) may be deposited on the upper surface of the substrate 10 to form the first metallic layer. At operation 204 the first metallic layer may be dewet to form the first nanoparticle mask 12′ on the upper surface 10a of the substrate 10. At operation 206 the first nanoparticle mask 12′ is etched where the etching beam is directed at the upper surface 10a at an angle normal to the upper surface of the substrate, to create the vertical rods 14. At operation 208 the second deposition operation is performed to deposit an additional quantity of metal material 12a on the upper surface 10a of the substrate, where the additional quantity of metal material 12a is deposited at an acute angle relative to the upper surface 10a of the substrate 10, to form the dash-like regions 16, and thus the secondary mask 12a′.

At operation 210 a second etching operation is performed (e.g., RIE, RIBE, etc.) using the secondary mask 12a′ to etch the dash-like voids 18 into the upper surface 10a of the substrate 10, and thus to form the finished metasurface 10a′ of the component 20.

The various embodiments and methods described herein can be used to construct components having a birefringent quality for use in a variety of optics and manufacturing applications. The various systems and methods described herein are expected to have particular utility in constructing waveplates for use with high power/energy laser systems, with significantly enhanced durability, stability, uniformity and substrate versatility. In some embodiments, the teachings herein may be used to construct ultraviolet quarter of wavelength waveplates-filling an important existing need for a variety of applications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for forming a component having a birefringent characteristic, comprising:
forming a first mask on a surface of a substrate of the component, the first mask being formed by a plurality of metallic nanoparticles;
performing a first etching operation, at a first angle, using the nanoparticle mask to remove material from the surface to create surface features projecting from the surface in accordance with the nanoparticle mask;
forming a second mask on the surface of the substrate by depositing an additional quantity of metallic material at a second angle relative to the surface, the second angle being different from the first angle, where the surface features help to create a plurality of regions adjacent each one of the surface features where the additional quantity of metallic material is absent; and
performing a second etching operation at a third angle relative to the surface of the substrate, using the second mask to remove additional substrate material from the substrate to create a plurality of voids in the surface of the substrate at each of the regions, the voids helping to form a metasurface which imparts birefringence to the component.

2. The method of claim 1, wherein the first etching operation is performed at an angle normal to the substrate, and the surface features created during the first etching operation comprise vertically projecting rods which extend normal to the surface of the substrate.

3. The method of claim 1, wherein the second angle at which the additional quantity of metallic material is deposited comprises an angle non-normal to the surface of the substrate.

4. The method of claim 2, wherein the vertically projecting rods form cylindrically shaped rods.

5. The method of claim 1, wherein the third angle at which the second etching operation is performed comprises an angle normal to the surface of the substrate, and wherein the regions comprise linear, dash-shaped regions.

6. The method of claim 1, wherein each of the plurality of voids comprise linear, dash-like voids.

7. The method of claim 1, wherein forming the first mask comprises depositing a first layer of metallic material and then dewetting the first layer of metal material to form the nanoparticles.

8. The method of claim 1, wherein forming the first mask comprises depositing a plurality of nanoparticles using a spin coating process.

9. The method of claim 1, wherein the first etching operation comprises a reactive ion etching (RIE) operation.

10. The method of claim 1, wherein the first etching operation comprises a reactive ion beam etch (RIBE) operation.

11. The method of claim 1, wherein the metallic material used to form the first mask comprises one of Au or Pt.

12. The method of claim 1, wherein the additional quantity of metallic material comprises one of Au or Pt.

13. The method of claim 1, wherein the second etching operation comprises a reactive ion etching (RIE) operation.

14. The method of claim 1, wherein the second etching operation comprises a reactive ion beam etching (RIBE) operation.

15. The method of claim 1, wherein the regions adjacent the features each have a crescent shape.

16. A method for forming a component having a birefringent characteristic, comprising:
forming a plurality of nanoparticles residing on the upper surface of a substrate, the plurality of nanoparticles forming a first mask on the upper surface of the substrate;
performing a first reactive ion etching operation using the first mask, and at an angle normal to the upper surface of the substrate, to remove material from the upper surface of the substrate to create vertical rods projecting from the upper surface in accordance with the first mask, the vertical rods being arranged in accordance with the locations of the nanoparticles of the first mask;
forming a second mask on the upper surface of the substrate by depositing an additional quantity of metallic material on the upper surface at an angle non-normal to the upper surface, wherein the second mask covers the upper surface except for a plurality of linear, dash-like regions adjacent each one of the rods where the additional quantity of metallic material is absent; and
performing a second etching operation using the second mask to create a plurality of dash-like voids at each of the dash-like regions, the dash-like voids helping to form a metasurface which imparts birefringence to the component.

17. The method of claim 16, wherein forming a first metallic layer of metallic material comprises forming a first metallic layer from at least one of Au or Pt.

18. The method of claim 16, wherein depositing an additional quantity of metallic material comprises depositing an additional quantity of at least one of Au or Pt.

19. The method of claim 16, subsequent to performing the second etching operation, performing an additional operation to remove the vertical rods.

20. A waveplate comprising:
a substrate;
a plurality of elongated voids formed in a surface of the substrate; and
the voids having at least one of a desired pattern or desired periodicity on the surface of the substrate and having a depth less than a thickness of the substrate, to provide a birefringent characteristic to the waveplate.
